(19) United States
(12) Patent Application Publication
(10) Pub. No.: US 2023/0058529 A1
(43) Pub. Date: Feb. 23, 2023

(54) MEETING ASSISTANCE APPARATUS AND MEETING ASSISTANCE METHOD

(71) Applicant: Mitsubishi Electric Corporation, Tokyo (JP)

(72) Inventors: Keisaku FUKUDA, Tokyo (JP); Mitsuo SHIMOTANI, Tokyo (JP)

(73) Assignee: Mitsubishi Electric Corporation, Tokyo (JP)

(21) Appl. No.: 17/793,345

(22) PCT Filed: Apr. 8, 2020
(86) PCT No.: PCT/JP2020/015760

§ 371 Date: Jul. 15, 2022

(51) Int. Cl. G06Q 10/10; G06Q 30/02; G06Q 50/30; G09F 21/04

(52) U.S. Cl. CPC G06Q 10/1095; G06Q 30/0266; G06Q 50/30; G09F 21/04

(57) ABSTRACT

It is an object to provide technology enabling appropriate control of a body system device mounted to a vehicle in meeting. A meeting assistance apparatus is a meeting assistance apparatus to assist a meeting user and the vehicle in meeting at a meeting point, and includes: an acquisition unit to acquire, from a mobile terminal of the meeting user contracted with the vehicle, control instructions to control the body system device mounted to the vehicle; and a controller to control the body system device based on the control instructions acquired by the acquisition unit when a predetermined condition to validate the control instructions is met.

### TECHNICAL FIELD

The present disclosure relates to meeting assistance apparatuses and meeting assistance methods.

### BACKGROUND ART

Various services on the shared use of a car have been put into practice or technologically developed. For example, a service that allows users to use vehicles that are not theirs as necessary, such as ridehailing and ridesharing, has been proposed. In such a service, it is important for a user to use a vehicle (a meeting user) and the vehicle (a meeting vehicle) to meet smoothly. To achieve such meeting, Patent Document 1 proposes technology of setting a meeting point as an imaginary rendezvous, and displaying the meeting point on a display of a map of an on-board information system, for example.

### PRIOR ART DOCUMENT

### Patent Document

Patent Document 1: Japanese Patent Application Laid-Open No. 2019-053547

### SUMMARY

### Problem to be Solved by the Invention

However, in a case where a plurality of vehicles of the same vehicle type as the meeting vehicle are stopped at the meeting point, for example, the meeting user cannot easily identify the meeting vehicle only from a display of the meeting point on the map, and is required to put time and effort into meeting in some cases.

The present disclosure has been conceived in view of a problem as described above, and it is an object of the present disclosure to provide technology enabling appropriate control of a body system device mounted to a vehicle in meeting.

### Means to Solve the Problem

A meeting assistance apparatus according to the present disclosure is a meeting assistance apparatus to assist a meeting user and a vehicle in meeting at a meeting point, and includes: an acquisition unit to acquire, from a mobile terminal of the meeting user contracted with the vehicle, control instructions to control a body system device mounted to the vehicle; and a controller to control the body system device based on the control instructions acquired by the acquisition unit when a predetermined condition to validate the control instructions is met.

### Effects of the Invention

According to the present disclosure, the body system device is controlled based on the acquired control instructions when the predetermined condition to validate the control instructions is met, so that the body system device can appropriately be controlled in meeting.

The objects, features, aspects, and advantages of the present disclosure will become more apparent from the following detailed description and the accompanying drawings.

### BRIEF DESCRIPTION OF DRAWINGS

FIG. 1 is a block diagram showing a configuration of a meeting assistance apparatus according to Embodiment 1.

FIG. 2 is a diagram for describing operation of the meeting assistance apparatus according to Embodiment 1.

FIG. 3 is a diagram for describing operation of the meeting assistance apparatus according to Embodiment 1.

FIG. 4 is a diagram for describing operation of the meeting assistance apparatus according to Embodiment 1.

FIG. 5 is a block diagram showing configurations of a meeting assistance apparatus and a mobile terminal according to Embodiment 2.

FIG. 6 is a flowchart showing operation on a side of a meeting vehicle according to Embodiment 2.

FIG. 7 is a diagram illustrating an example of a display of the meeting assistance apparatus according to Embodiment 2.

FIG. 8 is a diagram illustrating an example of a display of the meeting assistance apparatus according to Embodiment 2.

FIG. 9 is a diagram illustrating an example of a display of the meeting assistance apparatus according to Embodiment 2.

FIG. 10 is a diagram showing body system devices according to Embodiment 2.

FIG. 11 is a diagram for describing a display of an external illumination instrument according to Embodiment 2.

FIG. 12 is a diagram for describing a display of a window display instrument according to Embodiment 2.

FIG. 13 is a flowchart showing operation of the mobile terminal according to Embodiment 2.

FIG. 14 is a diagram illustrating an example of a display of the mobile terminal according to Embodiment 2.

FIG. 15 is a diagram illustrating an example of a display of the mobile terminal according to Embodiment 2.

FIG. 16 is a diagram illustrating an example of a display of the mobile terminal according to Embodiment 2.

FIG. 17 is a diagram for describing operation of a mobile terminal according to Modification 5 of Embodiment 2.

FIG. 18 is a flowchart showing operation on a side of a meeting vehicle according to Modification 6 of Embodiment 2.

FIG. 19 is a diagram illustrating an example of a display of a meeting assistance apparatus according to Modification 6 of Embodiment 2.

FIG. 20 is a diagram illustrating an example of a display of the meeting assistance apparatus according to Modification 6 of Embodiment 2.

FIG. 21 is a flowchart showing operation of a mobile terminal according to Modification 6 of Embodiment 2.

FIG. 22 is a block diagram showing configurations of a meeting assistance apparatus and a mobile terminal according to Embodiment 3.

FIG. 23 is a flowchart showing operation on a side of a meeting vehicle according to Embodiment 3.

FIG. 24 is a block diagram showing configurations of a meeting assistance apparatus, a mobile terminal, and a dispatch reservation server according to Embodiment 4.

FIG. 25 is a flowchart showing operation of the dispatch reservation server according to Embodiment 4.

FIG. 26 is a block diagram showing a hardware configuration of a meeting assistance apparatus according to another modification.

FIG. 27 is a block diagram showing a hardware configuration of a meeting assistance apparatus according to another modification.

FIG. 28 is a block diagram showing a configuration of a server according to another modification.

FIG. 29 is a block diagram showing a configuration of a communication terminal according to another modification.

### DESCRIPTION OF EMBODIMENTS

### Embodiment 1

A meeting assistance apparatus according to Embodiment 1 is an apparatus to assist a meeting user and a vehicle in meeting at a meeting point. A vehicle that the meeting user is to meet, such as a dispatched vehicle, is hereinafter also referred to as a “meeting vehicle”.

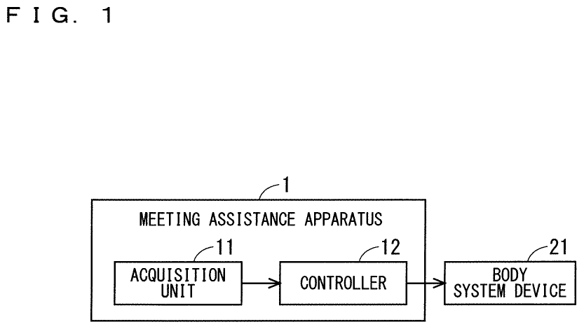

FIG. 1 is a block diagram showing a configuration of a meeting assistance apparatus 1 according to Embodiment 1. A configuration in which the meeting assistance apparatus 1 is mounted to the meeting vehicle will mainly be described below.

The meeting assistance apparatus 1 in FIG. 1 is communicatively connected to a body system device 21 mounted to the meeting vehicle wirelessly or by wire. The body system device 21 is a device that can provide a visual or an auditory notification to a person external to the meeting vehicle through control performed by the meeting assistance apparatus 1. Examples of the body system device 21 will be described in Embodiment 2 and the like.

The meeting assistance apparatus 1 in FIG. 1 includes an acquisition unit 11 and a controller 12.

The acquisition unit 11 acquires control instructions to control the body system device 21 from a mobile terminal of the meeting user. The mobile terminal of the meeting user is a mobile terminal contracted with the meeting vehicle, and is a mobile phone, a smartphone, a tablet, and the like contracted with the meeting vehicle for a service, such as ridesharing. The acquisition unit 11 includes at least one of a communication device that can wirelessly communicate with the mobile terminal and an interface thereof, for example.

The controller 12 controls the body system device 21 based on the control instructions acquired by the acquisition unit 11 when a predetermined condition to validate the control instructions (hereinafter, also referred to as a “control validation condition”) is met. Examples of the control validation condition will be described in Embodiment 2 and the like.

### Summary of Embodiment 1

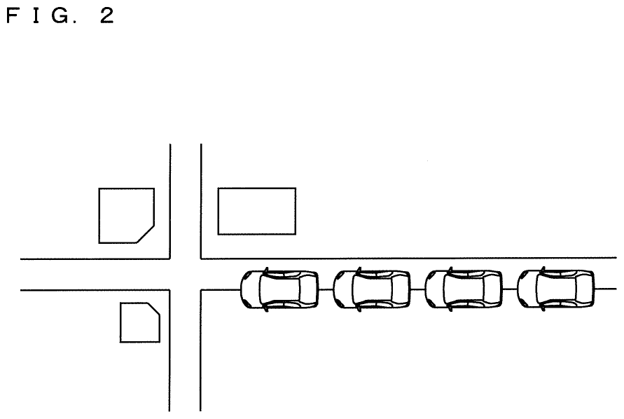

In a case where a plurality of vehicles of the same vehicle type as the meeting vehicle are stopped at the meeting point as illustrated in FIG. 2, the meeting user cannot easily identify the meeting vehicle. To address the problem, in the meeting assistance apparatus 1 according to Embodiment 1, the controller 12 controls the body system device 21 based on the control instructions acquired from the mobile terminal of the meeting user contracted with the meeting vehicle when the control validation condition is met.

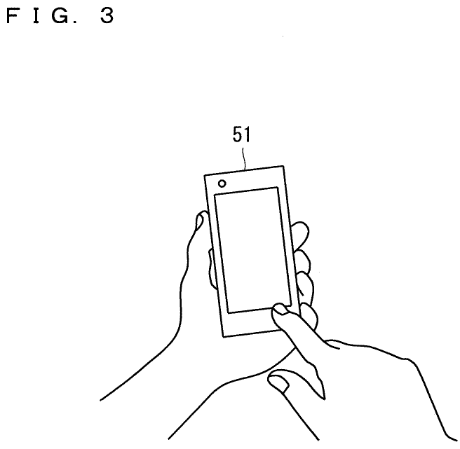

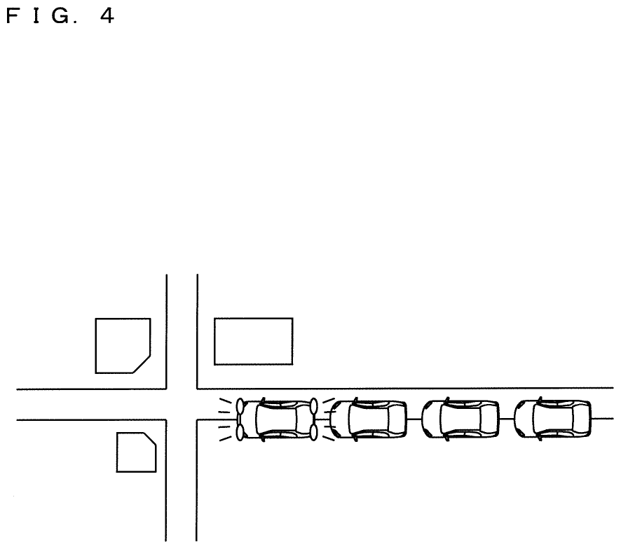

According to such a configuration, when the meeting user remotely operates the body system device 21 at his/her timing using his/her mobile terminal 51 as illustrated in FIG. 3, the body system device 21 of the meeting vehicle provides a visual or an auditory notification as illustrated in FIG. 4. The body system device 21 in FIG. 4 includes headlamps and tail lamps. The meeting user can identify, as the meeting vehicle, the vehicle providing the visual or auditory notification through control of the body system device 21 as described above. According to Embodiment 1, the body system device 21 can appropriately be controlled in meeting.

### Embodiment 2

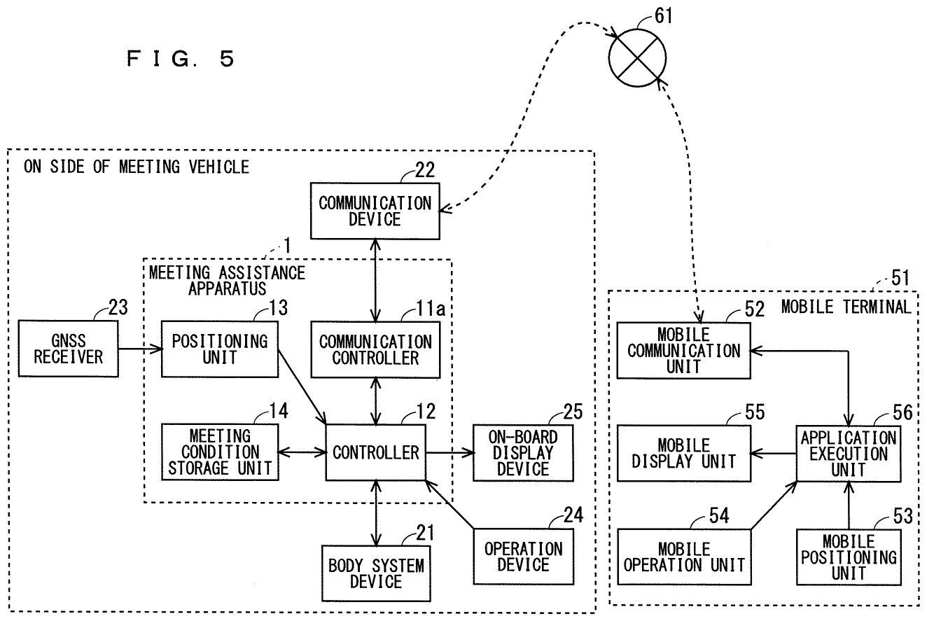

FIG. 5 is a block diagram showing configurations of the meeting assistance apparatus 1 and the mobile terminal 51 according to Embodiment 2. Components according to Embodiment 2 that are the same as or similar to the above-mentioned components bear reference signs that are the same as or similar to those of the above-mentioned components, and different components will mainly be described below.

<Components on Side of Meeting Vehicle>

Components on a side of the meeting vehicle in FIG. 5 include the meeting assistance apparatus 1, the body system device 21, a communication device 22, a global navigation satellite system (GNSS) receiver 23, an operation device 24, and an on-board display device 25. The meeting assistance apparatus 1 in FIG. 5 is connected to the body system device 21, the communication device 22, the GNSS receiver 23, the operation device 24, and the on-board display device 25.

The body system device 21 according to Embodiment 2 is similar to the body system device 21 according to Embodiment 1. The body system device 21 will be described below to include a plurality of body system instruments, but may include a single body system instrument.

The communication device 22 is a device to perform communication, such as wireless communication, with the exterior of the meeting vehicle, and performs communication with the mobile terminal 51 of the meeting user via a communication network 61. The communication network 61 includes at least one of a mobile communication network, a wireless local area network (LAN), and terminal-to-terminal communication, for example.

The GNSS receiver 23 receives information to identify the location of the meeting vehicle, such as a signal from a GNSS satellite.

The operation device 24 is a device to receive operation from a person on board of the meeting vehicle, and includes at least one of a button, a touch panel, an audio input device, and an image recognition device, for example.

The on-board display device 25 is a device to display various pieces of information in the meeting vehicle through control performed by the meeting assistance apparatus 1. The on-board display device 25 includes at least one of a liquid crystal display, an organic electroluminescence (EL) display, a display in an instrument panel, and a head-up display (HUD), for example. The on-board display device 25 may be a display device fixed to the meeting vehicle or may be a display device brought into the meeting vehicle.

The meeting assistance apparatus 1 in FIG. 5 includes a communication controller 11a, the controller 12, a positioning unit 13, and a meeting condition storage unit 14. The communication controller 11a in FIG. 5 is within the concept of the acquisition unit 11 in FIG. 1, and the controller 12 in FIG. 5 is within the concept of the controller 12 in FIG. 1.

The communication controller 11a controls communication performed by the communication device 22. By controlling communication, the communication controller 11a receives (acquires) the control instructions (instructions to control the body system device 21) and the like from the mobile terminal 51, and transmits various pieces of information to the mobile terminal 51.

The positioning unit 13 detects the location of the meeting vehicle based on the information received by the GNSS receiver 23. The positioning unit 13 may detect the location of the meeting vehicle based on not only the information received by the GNSS receiver 23 but also sensor information (e.g., a vehicle speed pulse, angular velocity, and acceleration) of the meeting vehicle, which is not shown.

The meeting condition storage unit 14 stores information of the meeting user, information of the meeting point, and the like as a meeting condition under which the meeting user and the meeting vehicle meet.

The controller 12 controls the body system device 21, the communication device 22, and the on-board display device 25 based on the information acquired by the communication controller 11a, the location detected by the positioning unit 13, the operation received by the operation device 24, and the meeting condition stored in the meeting condition storage unit 14. In description made below, the controller 12 is sometimes described to receive information even when the information is received by the communication device 22, and the controller 12 acquires the information through the communication controller 11a for convenience sake. The controller 12 is sometimes similarly described to transmit information even when the controller 12 transmits the information from the communication device 22 through the communication controller 11a for convenience sake.

The controller 12 controls the body system device 21 based on the control instructions acquired by the communication controller 11a when the control validation condition is met as in Embodiment 1. In Embodiment 2, description will be made by taking, as an example, a case where the control validation condition is a condition under which the distance between the meeting vehicle and the meeting point is less than or equal to a predetermined threshold.

<Components of Mobile Terminal>

The mobile terminal 51 in FIG. 5 includes a mobile communication unit 52, a mobile positioning unit 53, a mobile operation unit 54, a mobile display unit 55, and an application execution unit 56.

The mobile communication unit 52 has a similar function to the communication device 22, and performs communication with the communication device 22 via the communication network 61.

The mobile positioning unit 53 has a similar function to the GNSS receiver 23 and the positioning unit 13, and detects the location of the mobile terminal 51.

The mobile operation unit 54 has a similar function to the operation device 24, and receives operation from the meeting user.

The mobile display unit 55 has a similar function to the on-board display device 25, and displays various pieces of information in the mobile terminal 51.

The application execution unit 56 controls the mobile communication unit 52 and the mobile display unit 55 based on information received by the mobile communication unit 52, the location detected by the mobile positioning unit 53, and operation received by the mobile operation unit 54. In description made below, the application execution unit 56 is sometimes described to receive information even when the application execution unit 56 acquires the information received by the mobile communication unit 52 for convenience sake. The application execution unit 56 is sometimes similarly described to transmit information even when the application execution unit 56 transmits the information from the mobile communication unit 52.

The application execution unit 56 transmits the control instructions from the mobile communication unit 52 to the communication device 22 when a designated application is executed, and a certain condition is met.

<Operation on Side of Meeting Vehicle>

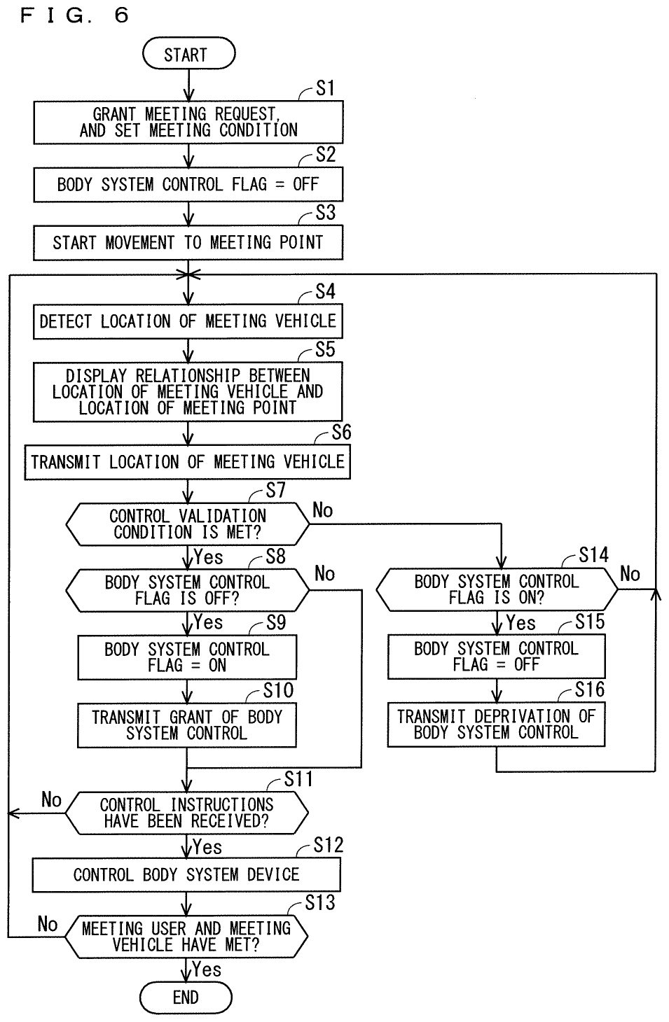

FIG. 6 is a flowchart showing operation on a side of the meeting vehicle according to Embodiment 2.

In step S1, the controller 12 grants a meeting request (dispatch request) transmitted from the mobile terminal 51 and the like when a check of an authentication key and the like transmitted from the mobile terminal 51 and the like is satisfied. The controller 12 then acquires a dispatch contract, such as information of the meeting user and information of the meeting point, transmitted from the mobile terminal 51 and the like as the meeting condition, and stores the meeting condition in the meeting condition storage unit 14. The meeting condition (dispatch contract) under which the meeting vehicle and the mobile terminal 51 meet is thereby set.

A body system control flag indicating whether the mobile terminal 51 is deprived of body system control or the body system control is granted to the mobile terminal 51 is herein used in Embodiment 2. Specifically, the body system control flag is off when control of the body system device 21 by the control instructions from the mobile terminal 51 is inhibited, that is, when the mobile terminal 51 is deprived of the body system control. The body system control flag is on when control of the body system device 21 by the control instructions from the mobile terminal 51 is allowed, that is, when the body system control is granted to the mobile terminal 51.

In step S2, the controller 12 turns off the body system control flag. In step S3, the meeting vehicle starts movement to the meeting point by driving of a driver. In step S4, the positioning unit 13 detects the location of the meeting vehicle.

In step S5, the controller 12 performs control to cause the on-board display device 25 to display a relationship between the location of the meeting vehicle detected by the positioning unit 13 and the location of the meeting point stored in the meeting condition storage unit 14.

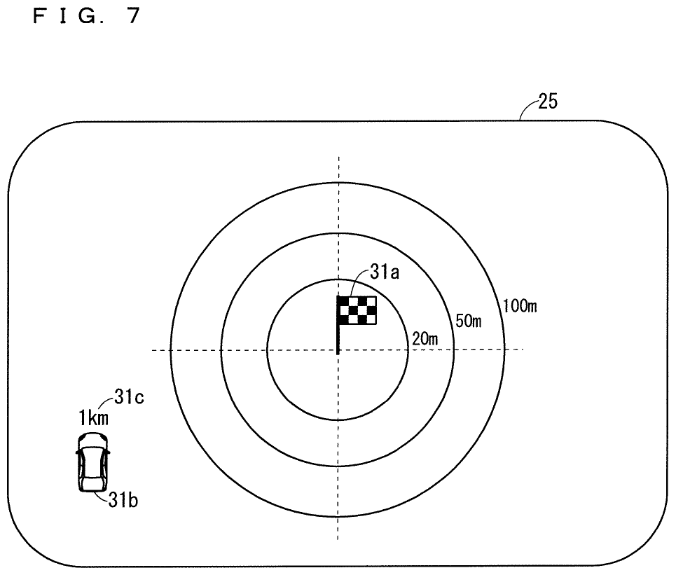

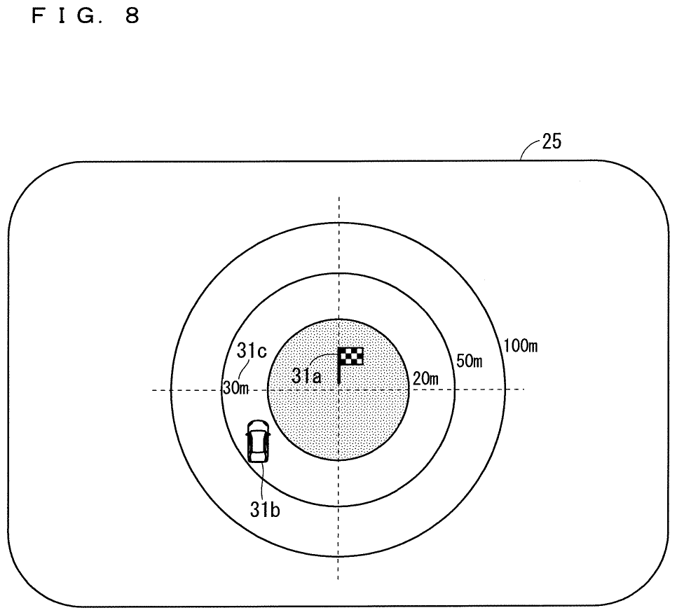

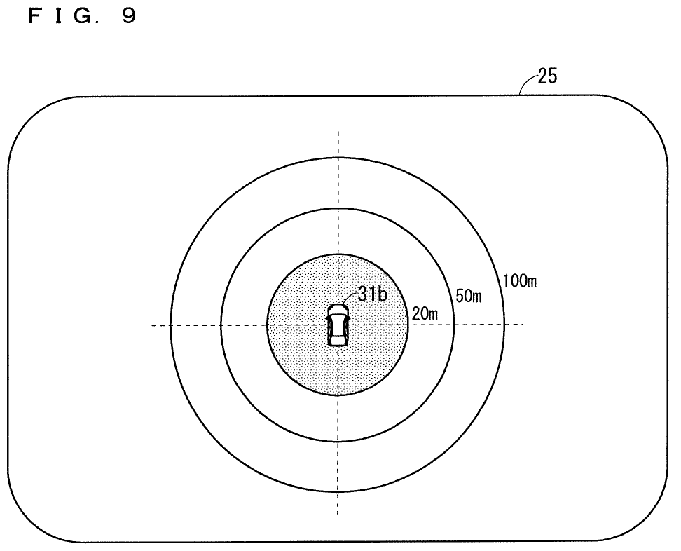

FIGS. 7 to 9 are diagrams each illustrating an example of a display in step S5. FIG. 7 illustrates an example of a display when the meeting vehicle is 100 m or more away from the meeting point, FIG. 8 illustrates an example of a display when the meeting vehicle is approximately 30 m away from the meeting point, and FIG. 9 illustrates an example of a display when the meeting vehicle arrives at the meeting point.

In FIG. 7, a display object 31a indicating the meeting point, circular scales having radii of 20 m, 50 m, and 100 m and each being centered at the display object 31a, a display object 31b indicating the meeting vehicle, and a display object 31c indicating the distance between the meeting vehicle and the meeting point in characters are displayed. According to a display as in FIG. 7, the distance and a direction to the meeting point to which the meeting vehicle is to head can be displayed.

In FIG. 8, the interior of a circular scale closer to the display object 31a than the display object 31b is shown in a light color. The display object 31a and the display object 31b in FIG. 8 have smaller sizes than the display object 31a and the display object 31b in FIG. 7 to make the relationship between the location of the meeting vehicle and the location of the meeting point more visible. As described above, the controller 12 may change the sizes of the display object 31a and the display object 31b based on the distance between the meeting point and the meeting vehicle. However, the sizes of the display object 31a and the display object 31b may not be changed, and, instead of changing the sizes thereof, spacing between the circular scales may be changed.

In FIG. 9, the display object 31a of the meeting point and the display object 31c indicating the distance are deleted. As described above, the controller 12 may delete the display object 31a and the display object 31c when the meeting vehicle arrives at the meeting point.

The display in step S5 is not limited to that in FIGS. 7 to 9, and the controller 12 may superimpose the display in FIGS. 7 to 9 on a map with buildings, roads, and the like for display, for example.

In step S6 after step S5 in FIG. 6, the controller 12 transmits the location of the meeting vehicle to the mobile terminal 51. When the mobile terminal 51 is configured to display the location of the meeting vehicle transmitted from the controller 12 on a side of the meeting vehicle, the meeting user having the mobile terminal 51 can know the location of the meeting vehicle.

In step S7, the controller 12 determines whether the control validation condition is met. In Embodiment 2, the controller 12 determines that the control validation condition is met when the distance between the meeting vehicle and the meeting point is less than or equal to a predetermined threshold (e.g., 20 m). Processing proceeds to step S8 when it is determined that the control validation condition is met, and proceeds to step S14 when it is determined that the control validation condition is not met.

In step S8, the controller 12 determines whether the body system control flag is off. Processing proceeds to step S9 when it is determined that the body system control flag is off, and proceeds to step S11 when it is determined that the body system control flag is not off.

In step S9, the controller 12 turns on the body system control flag. In step S10, the controller 12 transmits grant of the body system control to the mobile terminal 51. Processing then proceeds to step S11.

In step S11, the controller 12 determines whether the control instructions have been received from the mobile terminal 51. Processing proceeds to step S12 when it is determined that the control instructions have been received, and returns to step S4 when it is determined that the control instructions have not been received. When the control instructions having been received in step S11 are control instructions from a mobile terminal other than the mobile terminal 51 contracted in step S1, the controller 12 may ignore the control instructions, or may transmit non-grant of the body system control to the mobile terminal.

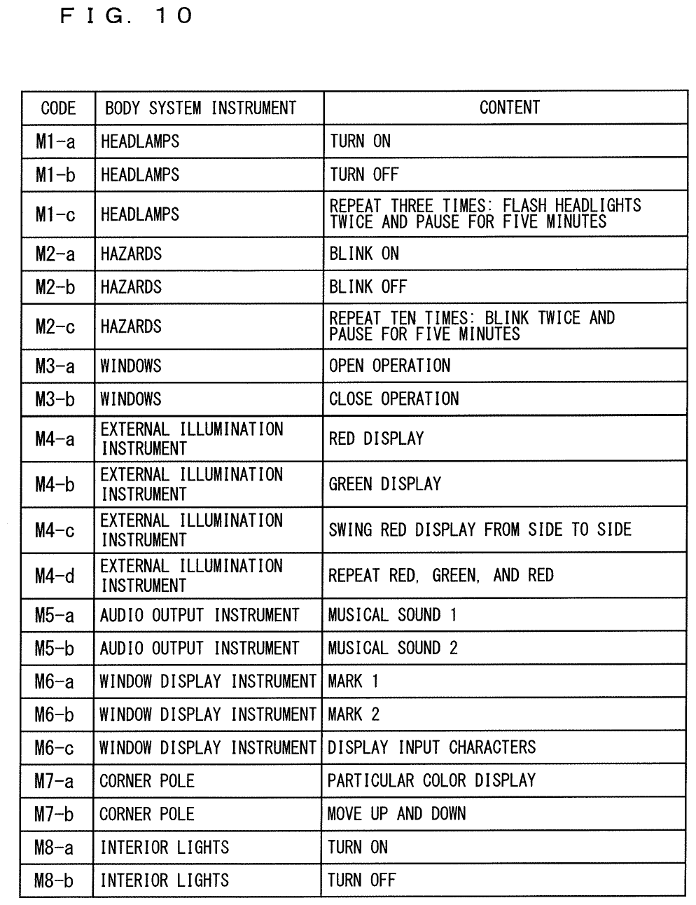

In step S12, the controller 12 controls the body system device 21 based on the control instructions. FIG. 10 is a diagram showing a plurality of body system instruments included in the body system device 21 according to Embodiment 2. As shown in FIG. 10, the body system device 21 according to Embodiment 2 includes, as the plurality of body system instruments, headlamps, hazards, windows, an external illumination instrument, an audio output instrument, a window display instrument, a corner pole, and interior lights of the meeting vehicle. Some of the body system instruments will be described below.

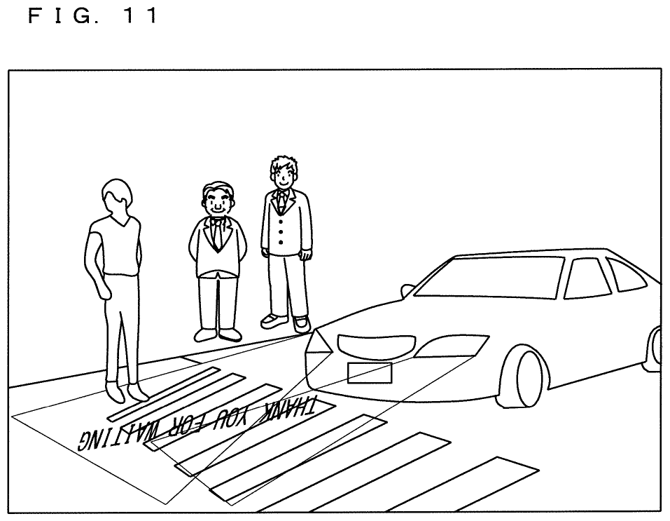

The headlamps are instruments to illuminate the exterior of the meeting vehicle. The external illumination instrument is an external display instrument to provide a display visible from the exterior of the meeting vehicle, and is an instrument to illuminate a road with characters and a plurality of colors for display as illustrated in FIG. 11. In an example of FIG. 11, the road is illuminated with characters “THANK YOU FOR WAITING”. The controller 12 may control an illumination direction of the external illumination instrument when controlling the display of the external illumination instrument.

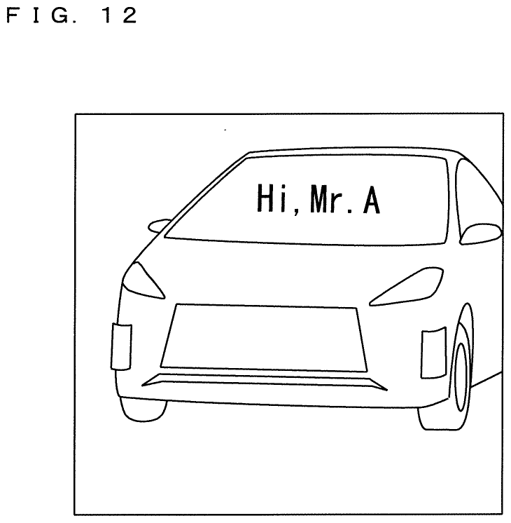

The audio output instrument is an instrument to output audio to the exterior of the meeting vehicle, and includes at least one of a horn and a speaker, for example. The window display instrument is an external display instrument to provide a display visible from the exterior of the meeting vehicle, and is an instrument to display characters and a plurality of colors on a window as illustrated in FIG. 12. The window display instrument includes a liquid crystal display attached to the window, for example. The interior lights are instruments to illuminate the interior of the meeting vehicle.

One or more controls are defined for each of the body system instruments in Embodiment 2 as shown in FIG. 10. A unique code is defined for each combination of one body system instrument and one control. In other words, the code is information to identify one of the plurality of body system instruments controllable based on the control instructions, and to identify one of a plurality of controls of the one of the body system instruments.

In Embodiment 2, the control instructions transmitted from the mobile terminal 51 include the above-mentioned code. When the control instructions having been received in step S11 in FIG. 6 include a code M1-a in FIG. 10, for example, the controller 12 turns on the headlamps of the meeting vehicle in step S12. When the control instructions having been received in step S11 include a code M1-b in FIG. 10, for example, the controller 12 turns off the headlamps of the meeting vehicle in step S12. Since the control instructions include the code as described above, different controls can be performed for each of the plurality of body system instruments. As a result, the meeting user can remotely operate various body system instruments to perform various controls using his/her mobile terminal 51, and thus can easily identify the meeting vehicle.

In step S13 after step S12 in FIG. 6, the controller 12 determines whether the meeting user and the meeting vehicle have met. For example, the controller 12 determines whether the meeting user and the meeting vehicle have met depending on whether operation performed when they meet has been received by the operation device 24. Operation in FIG. 6 ends when it is determined that they have met, and processing returns to step S4 when it is determined that they have not met.

When processing proceeds from step S7 to step S14, the controller 12 determines whether the body system control flag is on. Processing proceeds to step S15 when it is determined that the body system control flag is on, and returns to step S4 when it is determined that the body system control flag is not on.

In step S15, the controller 12 turns off the body system control flag. In step S16, the controller 12 transmits deprivation of the body system control to the mobile terminal 51. Processing then returns to step S4.

<Operation of Mobile Terminal>

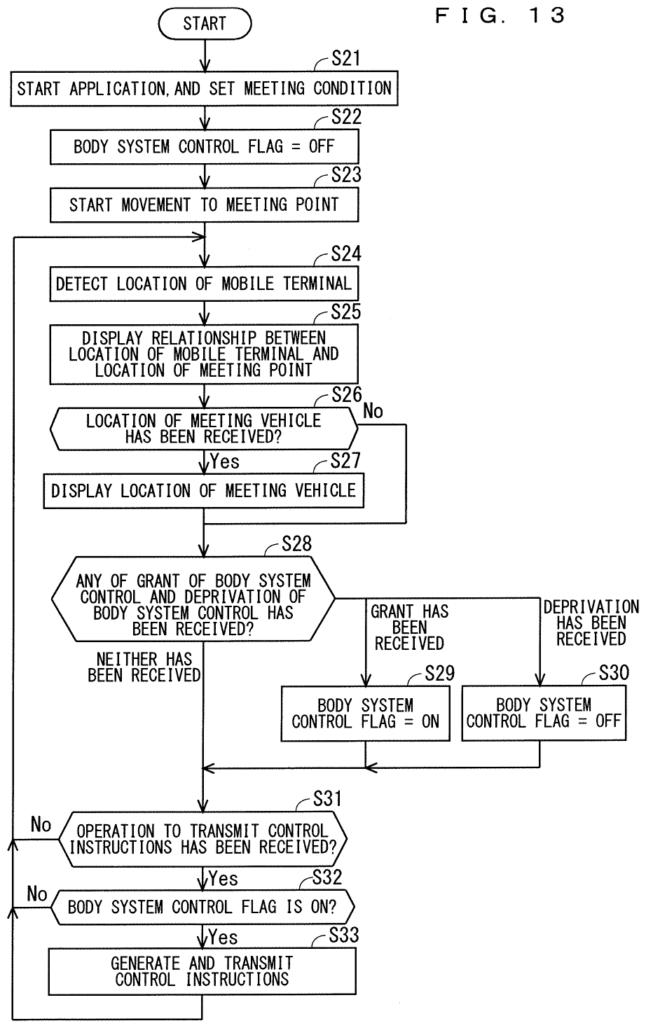

FIG. 13 is a flowchart showing operation of the mobile terminal 51 according to Embodiment 2.

In step S21, the application execution unit 56 transmits the authentication key to the meeting assistance apparatus 1 and the like of the meeting vehicle when an application for meeting, such as a dispatch application, is started. The application execution unit 56 also stores, as the meeting condition, the dispatch contract, such as information of the meeting vehicle and the information of the meeting point, transmitted from the meeting assistance apparatus 1 and the like. The meeting condition (dispatch contract) under which the meeting vehicle and the mobile terminal 51 meet is thereby set.

In step S22, the application execution unit 56 turns off the body system control flag. In step S23, the meeting user starts movement to the meeting point. In step S24, the mobile positioning unit 53 detects the location of the mobile terminal 51.

In step S25, the application execution unit 56 performs control to cause the mobile display unit 55 to display a relationship between the location of the mobile terminal 51 detected by the mobile positioning unit 53 and the stored location of the meeting point. The display in step S25 may be similar to that in FIGS. 7 to 9, may be a display using a map, or may be a display using text. The display in step S25 may be provided when the mobile operation unit 54 has received operation to provide the display in step S25.

In step S26, the application execution unit 56 determines whether the location of the meeting vehicle has been received. Processing proceeds to step S27 when it is determined that the location of the meeting vehicle has been received, and proceeds to step S28 when it is determined that the location of the meeting vehicle has not been received.

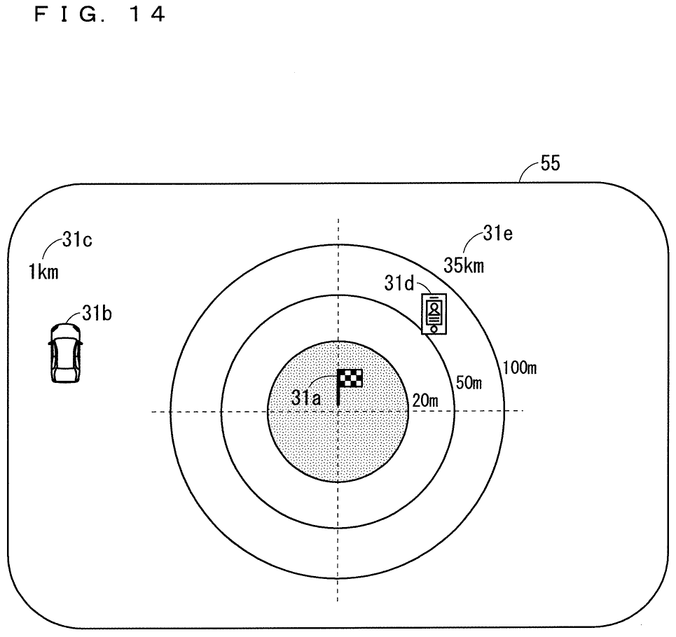

In step S27, the application execution unit 56 performs control to cause the mobile display unit 55 to display a relationship among the location of the meeting vehicle, the location of the meeting point, and the location of the mobile terminal 51. For example, the application execution unit 56 adds a display of the location of the meeting vehicle to the display in step S25. FIG. 14 is a diagram illustrating an example of a display in step S27. As illustrated in FIG. 14, a display object 31d indicating the mobile terminal 51 and a display object 31e indicating the distance between the mobile terminal 51 and the meeting point in characters are displayed in addition to the display in FIG. 7 in step S27. Processing proceeds to step S28 after step S27 in FIG. 13.

In step S28, the application execution unit 56 determines whether any of grant of the body system control and deprivation of the body system control has been received from the meeting assistance apparatus 1 of the meeting vehicle. Processing proceeds to step S29 when it is determined that grant of the body system control has been received, proceeds to step S30 when it is determined that deprivation of the body system control has been received, and proceeds to step S31 when it is determined that neither of them has been received.

In step S29, the application execution unit 56 turns on the body system control flag. Processing then proceeds to step S31.

In step S30, the application execution unit 56 turns off the body system control flag. Processing then proceeds to step S31.

In step S31, the application execution unit 56 determines whether the mobile operation unit 54 has received operation to transmit the control instructions. Processing proceeds to step S32 when it is determined that the operation has been received, and returns to step S24 when it is determined that the operation has not been received.

In step S32, the application execution unit 56 determines whether the body system control flag is on. Processing proceeds to step S33 when it is determined that the body system control flag is on, and returns to step S24 when it is determined that the body system control flag is off.

In step S33, the application execution unit 56 generates the control instructions based on operation determined to be received in step S31, and transmits the control instructions to the meeting assistance apparatus 1 of the meeting vehicle. Processing then returns to step S24.

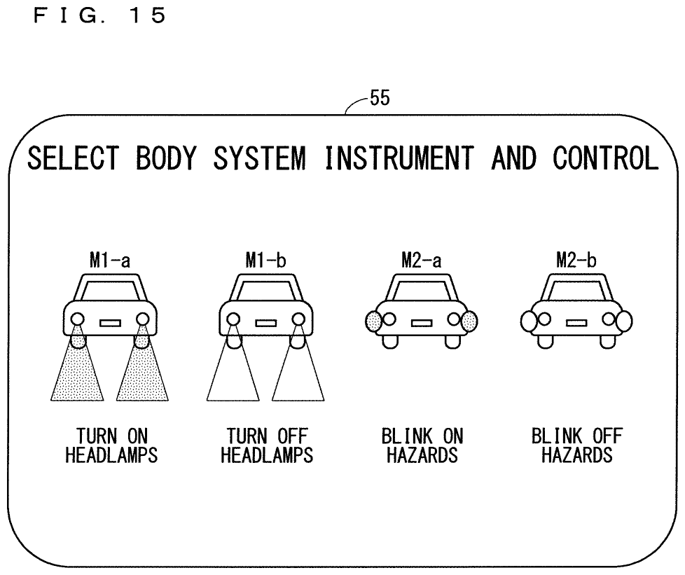

FIG. 15 is a diagram illustrating an example of a display of the mobile display unit 55 when operation has been received in step S31. FIG. 15 illustrates a display to select any one of turning on the headlamps (code M1-a), turning off the headlamps (code M1-b), blinking on the hazards (code M2-a), and blinking off the hazards (code M2-b). For example, in a case where touch operation to select an icon indicating turning on the headlamps from among the four icons in FIG. 15 is performed through the mobile operation unit 54 when the body system control flag is on, the control instructions corresponding to the icon is transmitted from the mobile terminal 51 to the meeting vehicle. The meeting user can thus control turning on the headlamps of the meeting vehicle by remote operation.

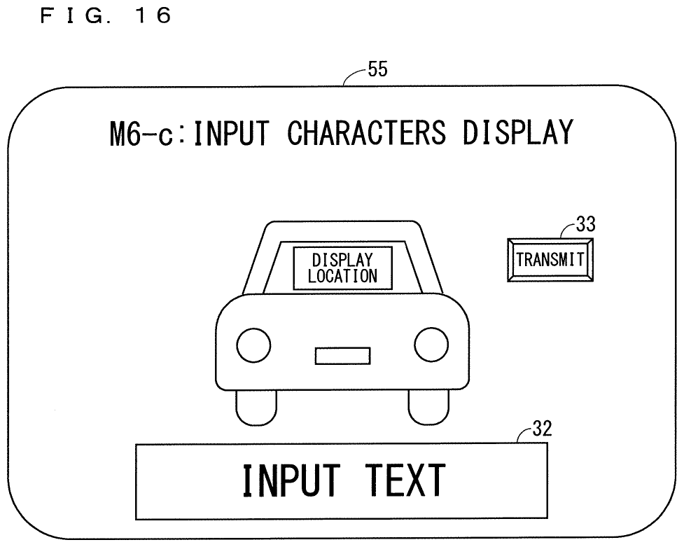

FIG. 16 is a diagram illustrating an example of a display of the mobile display unit 55 when operation is received in step S31. FIG. 16 illustrates a display to input characters in displaying characters (code M6-c) by the window display instrument in FIG. 10. For example, in a case where operation to input characters “Hi, Mr. A” into a text box 32, and touch a transmit button 33 is performed through the mobile operation unit 54 when the body system control flag is on, the control instructions including the characters are transmitted from the mobile terminal 51 to the meeting vehicle. The characters input into the text box 32 are thereby displayed on the window of the meeting vehicle as illustrated in FIG. 12. Initials of the meeting user, a password, and the like are preferable as the characters input into the text box 32.

While a display of characters of the window display instrument in FIG. 12 has been described herein, the external illumination instrument in FIG. 11 may provide a similar display of characters. Instead of displaying the characters input into the text box 32, audio converted from the characters may be output from the audio output instrument of the meeting vehicle.

While the body system control flag has been used in description made above, the body system control flag may not necessarily be used. When the body system control flag is used, however, the control instructions are not transmitted in step S33 even if operation to transmit the control instructions is received in step S31 unless it is determined that the body system control flag is on in step S32. Unnecessary transmission of the control instructions can thus be suppressed.

### Summary of Embodiment 2

According to the meeting assistance apparatus 1 according to Embodiment 2 as described above, the controller 12 controls the body system device 21 based on the control instructions acquired from the mobile terminal of the meeting user contracted with the meeting vehicle when the control validation condition is met. According to such a configuration, the body system device 21 can appropriately be controlled in meeting as in Embodiment 1.

The control validation condition according to Embodiment 2 includes the distance between the meeting vehicle and the meeting point being less than or equal to the predetermined threshold. According to such a configuration, unnecessary control of the body system device 21 of the meeting vehicle performed by the mobile terminal 51 can be suppressed.

The control validation condition may include time required for the meeting vehicle to arrive at the meeting point being less than or equal to a predetermined threshold. Even in this case, unnecessary control of the body system device 21 of the meeting vehicle performed by the mobile terminal 51 can be suppressed as described above.

### Modification 1 of Embodiment 2

In step S5 in FIG. 6 in Embodiment 2, the relationship between the location of the meeting vehicle and the location of the meeting point is displayed, but the location of the mobile terminal 51 is not displayed. However, when the meeting assistance apparatus 1 is configured to acquire the location of the mobile terminal 51, the relationship among the location of the meeting vehicle, the location of the meeting point, and the location of the mobile terminal 51 may be displayed as with the display of the mobile terminal 51 in FIG. 14.

The display in step S5 in FIG. 6, the display in step S25 in FIG. 13, and the display in step S27 in FIG. 13 may not necessarily be provided. However, by providing these displays as in Embodiment 2, one of the meeting user and the driver of the meeting vehicle can easily check whether the other has arrived at the meeting point.

When the control validation condition is met, at least one of the on-board display device 25 and the mobile display unit 55 may provide a display accordingly. Similarly, when grant or deprivation of the body system control occurs, at least one of the on-board display device 25 and the mobile display unit 55 may provide a display accordingly. Similarly, when the body system device 21 is controlled based on the control instructions, at least one of the on-board display device 25 and the mobile display unit 55 may provide a display accordingly.

### Modification 2 of Embodiment 2

While the control validation condition includes the distance between the meeting vehicle and the meeting point being less than or equal to the predetermined threshold in Embodiment 2, the control validation condition is not limited to this control validation condition. For example, the control validation condition may include the meeting vehicle being stopped or the meeting vehicle being stopped in a safe place, such as a road shoulder. For example, the control validation condition may include a speed of the meeting vehicle being less than or equal to a predetermined threshold (e.g., 10 km/h). According to the control validation condition as described above, control of the body system device 21 of the meeting vehicle during movement of the meeting vehicle can be suppressed.

### Modification 3 of Embodiment 2

While the above-mentioned control validation condition is a condition relating to the location and travel of the meeting vehicle, the control validation condition is not limited to this control validation condition. For example, the control validation condition may include the operation device 24 of the meeting vehicle receiving operation to validate the control instructions. According to such a configuration, control of the body system device 21 of the meeting vehicle before the driver of the meeting vehicle knows can be suppressed.

For example, the control validation condition may include the mobile operation unit 54 of the mobile terminal 51 receiving operation to ask for validation of the control instructions. Specifically, when the meeting user having the mobile terminal 51 has performed operation to ask for validation of the control instructions through the mobile operation unit 54, the mobile terminal 51 may notify the meeting assistance apparatus 1 accordingly, and the meeting assistance apparatus 1 may cause the on-board display device 25 to provide a display accordingly. In this case, the controller 12 may determine that the control validation condition is met when the driver of the meeting vehicle has performed operation to validate the control instructions through the operation device 24.

For example, the control validation condition may include the mobile operation unit 54 receiving operation to ask for validation of the control instructions, and a dispatch reservation server, which will be described below, determining to validate the control instructions based on the meeting condition and the like.

### Modification 4 of Embodiment 2

Even when the control instructions are transmitted from the mobile terminal 51 to one body system instrument, the one body system instrument is sometimes not a target of the control instructions in the meeting vehicle, and thus not controllable based on the control instructions. The controller 12 of the meeting assistance apparatus 1 thus may perform control to transmit a list or an image of a plurality of body system instruments controllable based on the control instructions as in a column “BODY SYSTEM INSTRUMENT” in FIG. 10 from the meeting vehicle to the mobile terminal 51.

The mobile terminal 51 may cause the mobile display unit 55 to display the list or the image when receiving the list or the image. Furthermore, when touch operation to select some of the body system instruments from the displayed list or image is performed through the mobile operation unit 54, the mobile terminal 51 may provide a display to select a body system instrument as in FIG. 15.

According to such a configuration, the meeting user can transmit the control instructions from the mobile terminal 51 after checking the plurality of body system instruments as the target of the control instructions in the meeting vehicle. The controller 12 may perform control to transmit controls as in a column “CONTROL” in FIG. 10 in addition to the above-mentioned list or the above-mentioned image from the meeting vehicle to the mobile terminal 51.

### Modification 5 of Embodiment 2

The same control validation condition is used for each of the body system instruments in Embodiment 2. The control validation condition, however, may be different for each of the body system instruments. Furthermore, in a configuration in which the body system device 21 includes a first body system instrument and a second body system instrument, the control validation condition for the first body system instrument may be more constrained than the control validation condition for the second body system instrument.

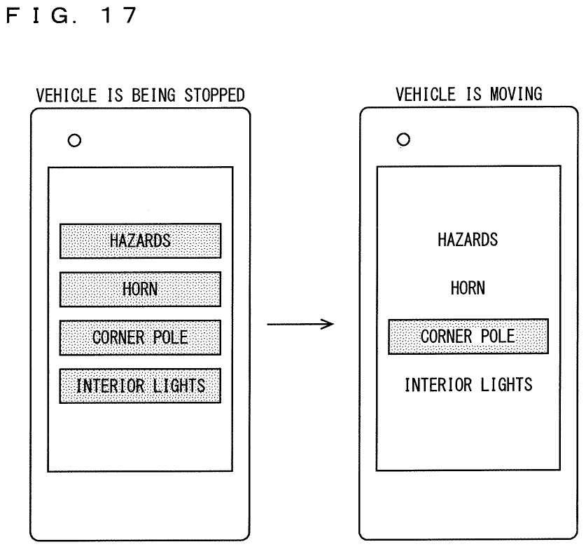

For example, in FIG. 17, the control validation condition for the corner pole is less constrained as control of the corner pole performed by the mobile terminal 51 is allowed even when the meeting vehicle is being stopped or is moving. The corner pole thus corresponds to the first body system instrument. On the other hand, the control validation condition for each of the hazards, the audio output instrument, and the headlamps is more constrained as control thereof performed by the mobile terminal 51 is inhibited when the meeting vehicle is moving, and is allowed when the meeting vehicle is being stopped. The hazards, the audio output instrument, and the headlamps thus each correspond to the second body system instrument.

As another example, control of the body system instruments having codes M1 to M3 in FIG. 10 performed by the mobile terminal 51 may be inhibited when the distance between the meeting vehicle and the meeting point is less than or equal to 30 m, and the meeting vehicle is moving. In this case, control of the body system instruments having codes M4 to M7 in FIG. 10 performed by the mobile terminal 51 may be allowed. On the other hand, control of the body system instruments having codes M1 to M7 in FIG. 10 performed by the mobile terminal 51 may be allowed when the distance between the meeting vehicle and the meeting point is less than or equal to 30 m, and the meeting vehicle is being stopped.

According to such a configuration, unnecessary control of the body system device 21 of the meeting vehicle performed by the mobile terminal 51 can appropriately be suppressed.

### Modification 6 of Embodiment 2

The meeting point is fixed in Embodiment 2. The meeting point, however, may not be fixed, and the meeting point may be the location of the mobile terminal 51 of the meeting user for the meeting vehicle, and may be the location of the meeting vehicle for the mobile terminal 51 of the meeting user, for example.

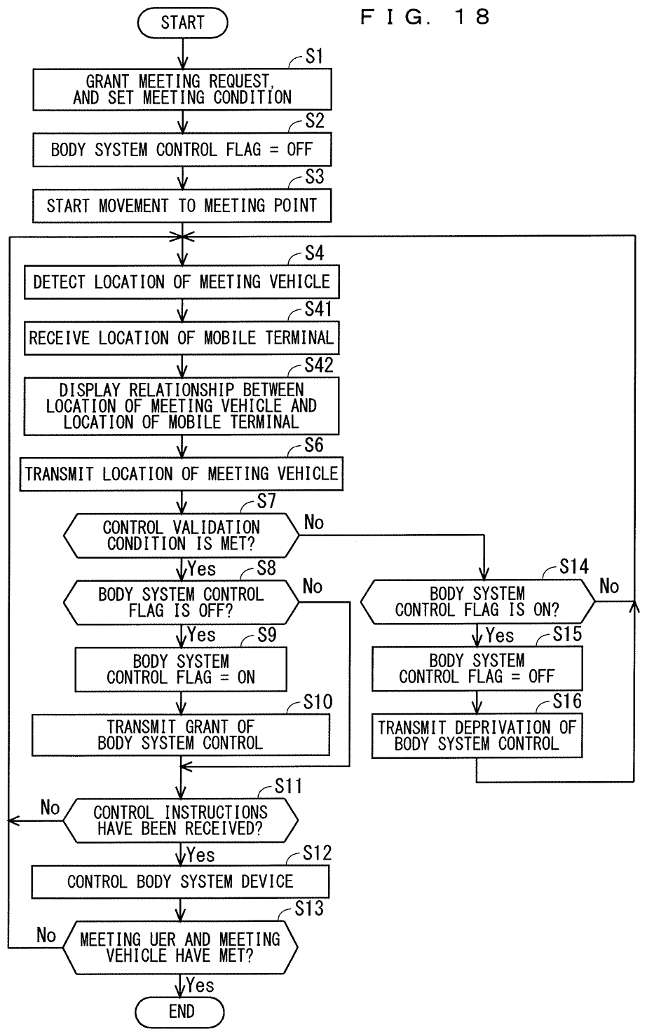

FIG. 18 is a flowchart showing operation on a side of a meeting vehicle according to Modification 6. Operation in FIG. 18 is similar to operation in the flowchart of FIG. 6 in which step S5 has been replaced with steps S41 and S42. Steps S41 and S42 will mainly be described below.

In step S41, the controller 12 receives the location of the mobile terminal 51. In step S42, the controller 12 performs control to cause the on-board display device 25 to display the relationship between the location of the meeting vehicle and the location of the mobile terminal 51.

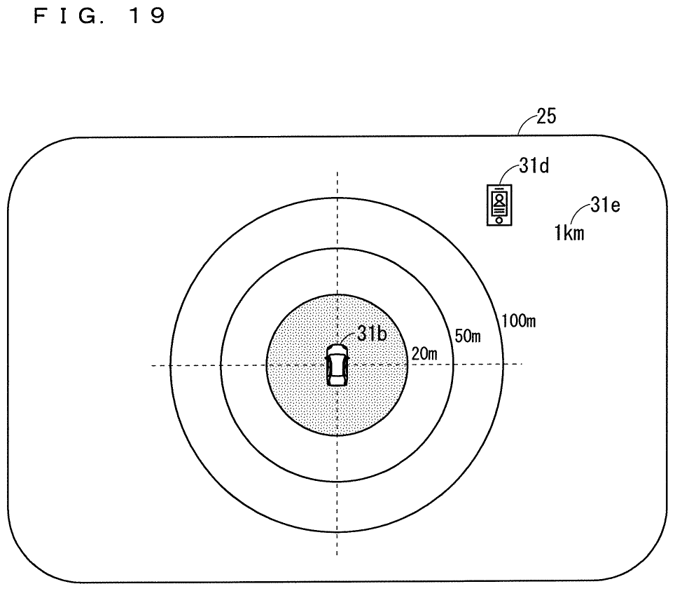

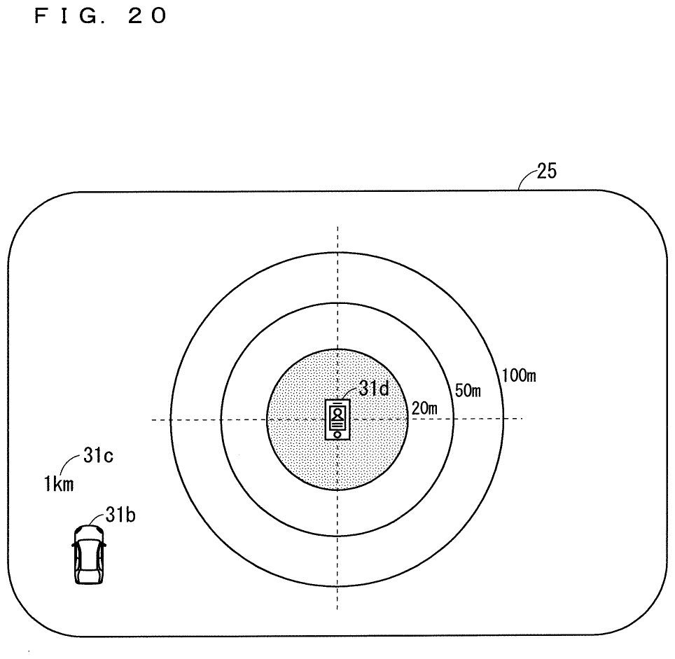

FIGS. 19 and 20 are diagrams each illustrating an example of a display in step S41. The location of the mobile terminal 51 is displayed with the meeting vehicle at the center in FIG. 19, and the location of the meeting vehicle is displayed with the mobile terminal 51 at the center in FIG. 20. In the example of the display in each of FIGS. 19 and 20, a display of the display object 31a indicating the meeting point is omitted in contrast to the example of the display in FIG. 7 and the like.

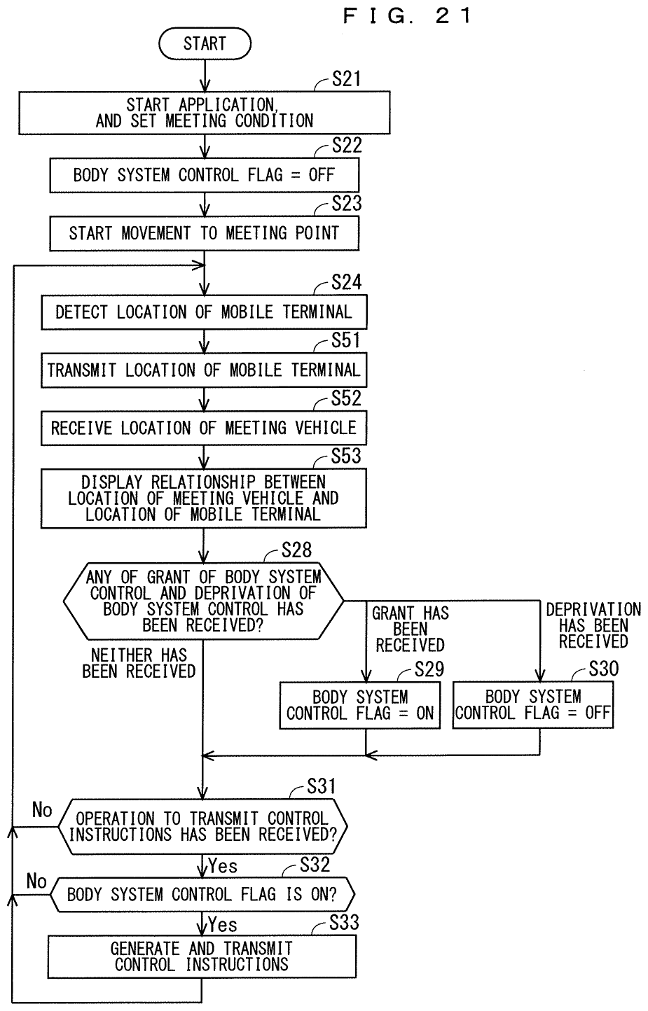

FIG. 21 is a flowchart showing operation of the mobile terminal 51 according to Modification 6. Operation in FIG. 21 is similar to operation in the flowchart of FIG. 13 in which steps S25 to S27 have been replaced with steps S51 to S53. Steps S51 to S53 will mainly be described below.

In step S51, the application execution unit 56 transmits the location of the mobile terminal 51 to the meeting assistance apparatus 1 of the meeting vehicle. In step S52, the application execution unit 56 receives the location of the meeting vehicle. In step S53, the application execution unit 56 displays the relationship between the location of the meeting vehicle and the location of the mobile terminal 51. The display in step S53 may be the same as the display in step S41 (FIGS. 19 and 20).

According to a configuration as described above, the meeting user and the meeting vehicle can meet flexibly. A meeting time point or meeting time may be set, and, in this case, the meeting time point or the meeting time may be changed as appropriate at the convenience of the meeting user or the meeting vehicle.

While Modifications 1 to 6 of Embodiment 2 have been described so far, Embodiment 2 and Modifications 1 to 6 may be combined as appropriate.

### Embodiment 3

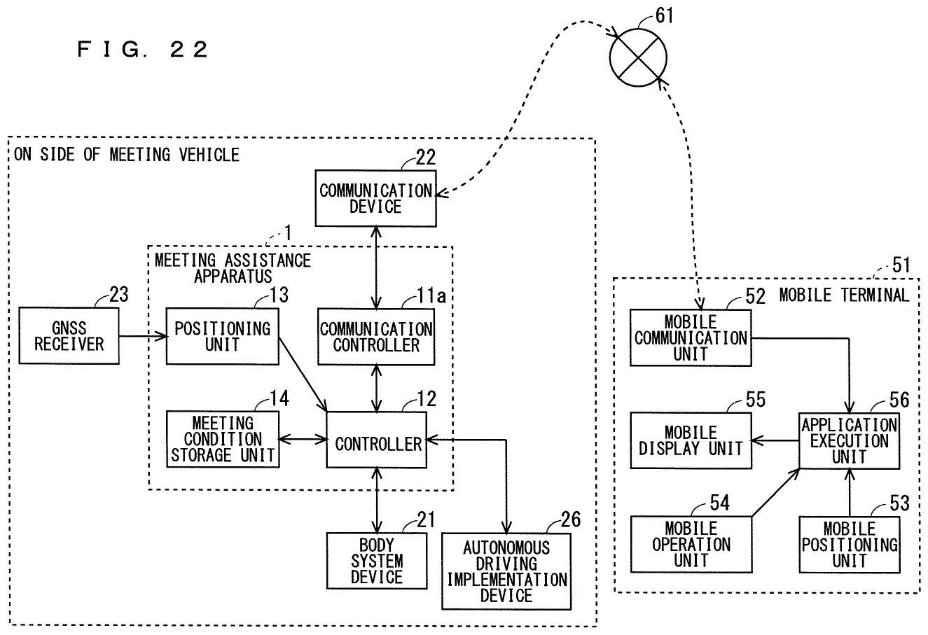

FIG. 22 is a block diagram showing configurations of the meeting assistance apparatus 1 and the mobile terminal 51 according to Embodiment 3. Components according to Embodiment 3 that are the same as or similar to the above-mentioned components bear reference signs that are the same as or similar to those of the above-mentioned components, and different components will mainly be described below.

A configuration of the meeting assistance apparatus 1 in FIG. 22 is similar to the configuration of the meeting assistance apparatus 1 in FIG. 5 in which the operation device 24 and the on-board display device 25 have been replaced with an autonomous driving implementation device 26.

The autonomous driving implementation device 26 implements full autonomous driving of the meeting vehicle to move the meeting vehicle to the meeting point. While the meeting vehicle according to Embodiment 2 is a vehicle driven by a person, the meeting vehicle according to Embodiment 3 is an autonomous vehicle, such as a so-called robotaxi, not required to be driven by a person.

<Operation>

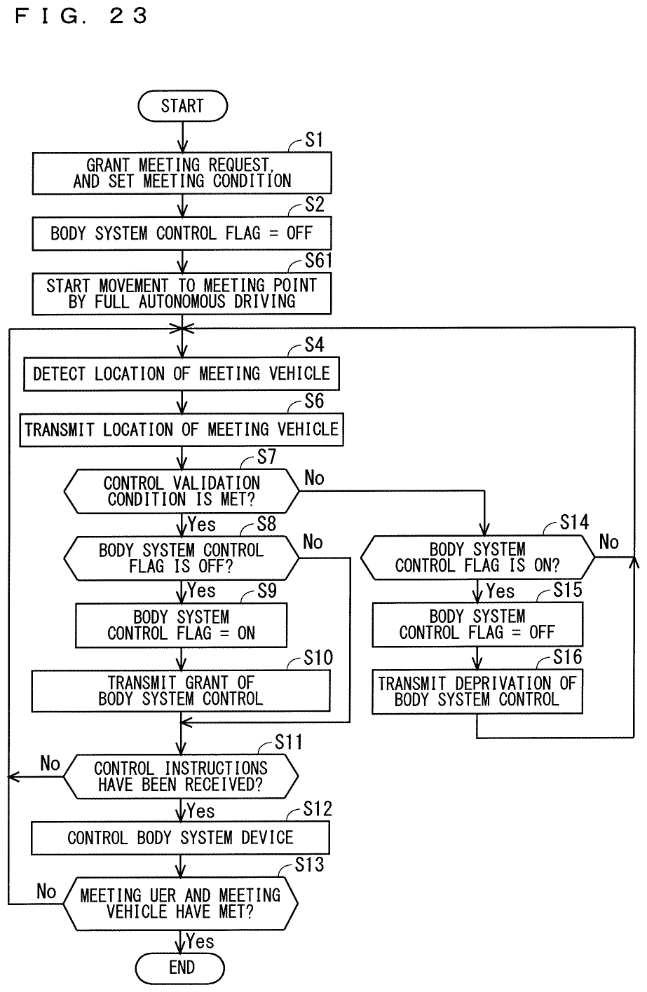

FIG. 23 is a flowchart showing operation on a side of a meeting vehicle according to Embodiment 3. Operation in FIG. 23 is similar to operation in the flowchart of FIG. 6 in which step S5 has been deleted, and step S3 has been replaced with step S61. Step S61 will thus mainly be described herein. In step S61, the meeting vehicle starts movement to the meeting point by full autonomous driving implemented by the autonomous driving implementation device 26.

A configuration and operation of the mobile terminal 51 according to Embodiment 3 are similar to the configuration and operation of the mobile terminal 51 according to Embodiment 2.

### Summary of Embodiment 3

According to the meeting assistance apparatus 1 according to Embodiment 3 as described above, the body system device 21 can appropriately be controlled in meeting as in Embodiment 2 even when the meeting vehicle is the autonomous vehicle.

### Modification of Embodiment 3

While the meeting vehicle is the autonomous vehicle in Embodiment 3, the meeting vehicle is not limited to the autonomous vehicle. For example, the meeting vehicle may be a remotely operated vehicle that moves by remote operation of a remote driver. In this case, interaction between a human machine interface of a remote driving device and the remote driver is performed in place of interaction between a human machine interface on a side of the meeting vehicle and the driver of the meeting user described in Embodiment 2.

While the on-board display device 25 has been deleted from the configuration in FIG. 22, and step S5 has been deleted from operation in FIG. 23 in Embodiment 3, they may not be deleted.

### Embodiment 4

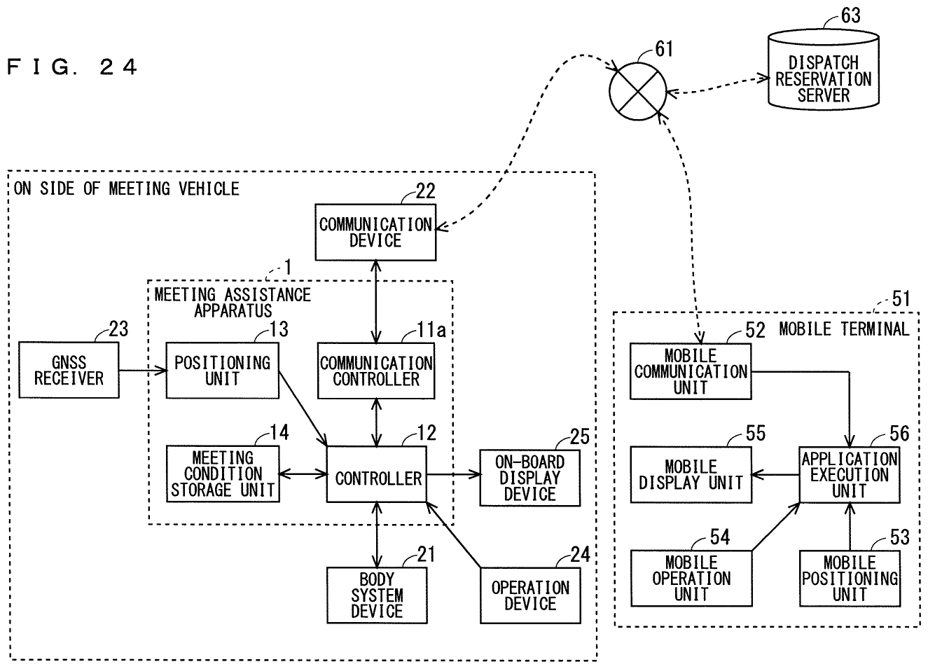

FIG. 24 is a block diagram showing configurations of the meeting assistance apparatus 1, the mobile terminal 51, and a dispatch reservation server 63 according to Embodiment 4. Components according to Embodiment 4 that are the same as or similar to the above-mentioned components bear reference signs that are the same as or similar to those of the above-mentioned components, and different components will mainly be described below. In description made below, the dispatch request corresponds to the meeting request, the dispatched vehicle corresponds to the meeting vehicle, the dispatch contract corresponds to the meeting condition, and whether to allow dispatch corresponds to whether to allow meeting.

The dispatch reservation server 63 as a server in FIG. 24 can communicate with the meeting assistance apparatus 1 and the mobile terminal 51 via the communication network 61. The dispatch reservation server 63 arbitrates between candidates for the dispatched vehicle and the mobile terminal 51 based on the dispatch request from the mobile terminal 51, and sets the dispatch contract. While the dispatch contract (meeting condition) is set between the meeting vehicle and the mobile terminal 51 in Embodiment 2, the dispatch contract is set by the dispatch reservation server 63 in Embodiment 4.

A configuration on a side of the meeting vehicle according to Embodiment 4 is similar to the configuration on the side of the meeting vehicle according to Embodiment 2, and a configuration of the mobile terminal 51 according to Embodiment 4 is similar to the configuration of the mobile terminal 51 according to Embodiment 2.

<Operation>

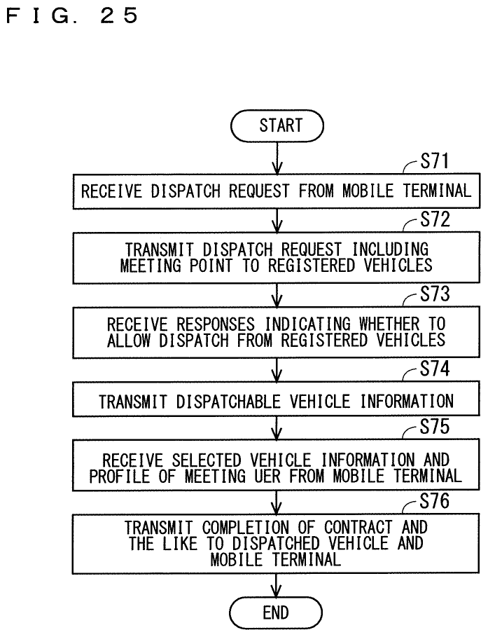

FIG. 25 is a flowchart showing operation of the dispatch reservation server 63 according to Embodiment 4.

In step S71, the dispatch reservation server 63 receives the dispatch request from the mobile terminal 51. The dispatch request includes a meeting point that the meeting user desires. The dispatch request may further include a vehicle type that the meeting user desires.

In step S72, the dispatch reservation server 63 transmits the dispatch request including the meeting point to one or more pre-registered vehicles each meeting a certain number of dispatch requests of the above-mention dispatch request. The registered vehicles having received the dispatch request or drivers thereof each transmit a response indicating that dispatch is allowed to the dispatch reservation server 63 when determining that the dispatch request can be met, and transmit a response indicating that dispatch is not allowed to the dispatch reservation server 63 when determining that the dispatch request cannot be met.

In step S73, the dispatch reservation server 63 receives responses indicating whether to allow dispatch from the registered vehicles.

In step S74, the dispatch reservation server 63 transmits, to the mobile terminal 51, dispatchable vehicle information indicating vehicles whose responses indicating whether to allow dispatch are responses indicating that dispatch is allowed as candidates for the dispatched vehicle. The dispatchable vehicle information includes profiles and an estimated arrival time list of the candidates for the dispatched vehicle whose responses indicating whether to allow dispatch are responses indicating that dispatch is allowed, for example.

In step S75, the dispatch reservation server 63 receives, from the mobile terminal 51, selected vehicle information indicating one of the candidates for the dispatched vehicle selected by the mobile terminal 51 and a profile of the meeting user.

In step S76, the dispatch reservation server 63 determines the vehicle indicated by the selected vehicle information as the dispatched vehicle, and transmits completion of a contract, the meeting point, and the profile of the meeting user to the dispatched vehicle. The dispatch reservation server 63 also transmits completion of the contract and the meeting point to the mobile terminal 51. Operation in FIG. 25 then ends.

Operation on the side of the meeting vehicle according to Embodiment 4 is similar to operation on the side of the meeting vehicle according to Embodiment 2 except that the dispatch reservation server 63 performs part of processing in step S1 of operation on the side of the meeting vehicle according to Embodiment 2 (FIG. 6). Similarly, operation of the mobile terminal 51 according to Embodiment 4 is similar to operation of the mobile terminal 51 according to Embodiment 2 except that the dispatch reservation server 63 performs part of processing in step S21 of operation of the mobile terminal 51 according to Embodiment 2 (FIG. 13).

### Summary of Embodiment 4

According to the meeting assistance apparatus 1 according to Embodiment 4 as described above, the vehicle and the mobile terminal 51 are each not required to have a function of setting the meeting condition.

### Modification 1 of Embodiment 4

While the dispatch reservation server 63 has been added to the configuration in Embodiment 2 in Embodiment 4, the dispatch reservation server 63 may be added to the configuration in Embodiment 3 in which the meeting vehicle is the autonomous vehicle. The dispatch reservation server 63 may be added to the configuration in the modification of Embodiment 3 in which the meeting vehicle is the remotely operated vehicle.

### Modification 2 of Embodiment 4

Information from the dispatched vehicle may be transmitted to the mobile terminal 51 via the dispatch reservation server 63. For example, the location of the meeting vehicle transmitted in step S6, grant of the body system control transmitted in step S10, deprivation of the body system control transmitted in step S16 in FIG. 6, and a result of the check of the authentication key of the mobile terminal 51 may be transmitted to the mobile terminal 51 via the dispatch reservation server 63.

Information from the mobile terminal 51 may be transmitted to the meeting vehicle via the dispatch reservation server 63. For example, the control instructions transmitted in step S33 in FIG. 13 may be transmitted to the meeting vehicle via the dispatch reservation server 63.

### Other Modifications

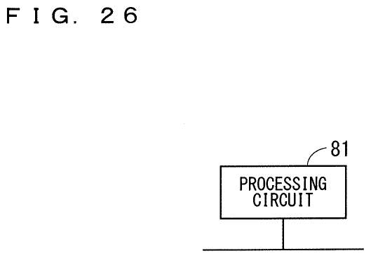

The acquisition unit 11 and the controller 12 in FIG. 1 described above are referred to as the “acquisition unit 11 and the like” below. The acquisition unit 11 and the like are achieved by a processing circuit 81 shown in FIG. 26. That is to say, the processing circuit 81 includes the acquisition unit 11 to acquire, from the mobile terminal of the meeting user contracted with the vehicle, the control instructions to control the body system device mounted to the vehicle, and the controller 12 to control the body system device based on the control instructions acquired by the acquisition unit when the predetermined condition to validate the control instructions is met. Dedicated hardware or a processor to execute a program stored in a memory may be applied to the processing circuit 81. The processor corresponds to a central processing unit, a processing unit, an arithmetic unit, a microprocessor, a microcomputer, a digital signal processor (DSP), and the like, for example.

When the processing circuit 81 is the dedicated hardware, the processing circuit 81 corresponds to a single circuit, a composite circuit, a programmed processor, a parallel programmed processor, an application specific integrated circuit (ASIC), a field programmable gate array (FPGA), and a combination thereof, for example. The functions of the components such as the acquisition unit 11 and the like may be achieved by distributed processing circuits, or may collectively be achieved by a single processing circuit.

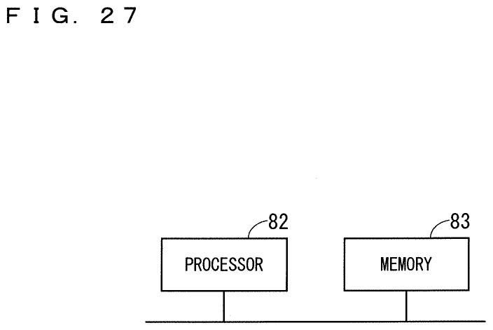

When the processing circuit 81 is the processor, the functions of the acquisition unit 11 and the like are achieved by combination with software and the like. The software and the like correspond to software, firmware, or software and firmware, for example. The software and the like are described as the program, and stored in the memory. As shown in FIG. 27, a processor 82 applied to the processing circuit 81 reads and executes the program stored in a memory 83 to achieve the functions of the components. That is to say, the meeting assistance apparatus 1 includes the memory 83 to store the program which, when executed by the processing circuit 81, results in performance of steps including: acquiring, from the mobile terminal of the meeting user contracted with the vehicle, the control instructions to control the body system device mounted to the vehicle; and controlling the body system device based on the acquired control instructions when the predetermined condition to validate the control instructions is met. In other words, the program causes a computer to execute procedures or methods of the acquisition unit 11 and the like. The memory 83 herein may be, for example, a nonvolatile or volatile semiconductor memory, such as a random access memory (RAM), a read only memory (ROM), a flash memory, an erasable programmable read only memory (EPROM), and an electrically erasable programmable read only memory (EEPROM), a hard disk drive (HDD), a magnetic disk, a flexible disk, an optical disc, a compact disc, a mini disc, a digital versatile disc (DVD), a drive device thereof, and the like or any storage medium to be used in the future.

A configuration in which the functions of the acquisition unit 11 and the like are achieved either by hardware or by software is described above. The configuration, however, is not limited to this configuration, and one of the acquisition unit 11 and the like may be achieved by dedicated hardware, and the other may be achieved by software and the like. For example, the function of the acquisition unit 11 can be achieved by the processing circuit 81 as the dedicated hardware, an interface, a receiver, and the like, and the functions of the other components can be achieved by the processing circuit 81 as the processor 82 reading and executing the program stored in the memory 83.

As described above, the processing circuit 81 can achieve the above-mentioned functions by hardware, software, or a combination thereof.

The meeting assistance apparatus 1 described above is applicable to a meeting assistance system configured as a system by combining a vehicle device, such as a portable navigation device (PND) and a navigation device, a communication terminal including a mobile terminal, such as a mobile phone, a smartphone, and a tablet, a function of an application installed on at least one of the vehicle device and the communication terminal, and a server as appropriate. In this case, the functions or the components of the meeting assistance apparatus 1 described above may be distributed among the instruments constituting the system, or may be concentrated on any of the instruments.

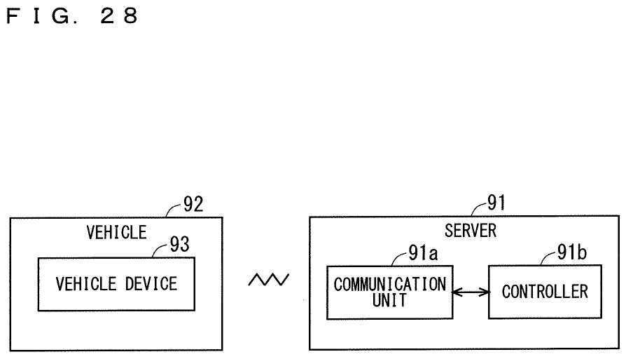

FIG. 28 is a block diagram showing a configuration of a server 91 according to a modification. The server 91 in FIG. 28 includes a communication unit 91a and a controller 91b, and can wirelessly communication with a vehicle device 93, such as the navigation device, of a vehicle 92.

The communication unit 91a as the acquisition unit wirelessly communicates with the vehicle device 93 to acquire the control instructions from the mobile terminal and determination information to determine the predetermined condition to validate the control instructions. The communication unit 91a may wirelessly communicate not with the vehicle device 93 but with the mobile terminal to directly acquire the control instructions from the mobile terminal.

The controller 91b has a similar function to the controller 12 in FIG. 1 by an unillustrated processor and the like of the server 91 executing a program stored in an unillustrated memory of the server 91. That is to say, the controller 91b generates a control signal to control the body system device of the vehicle 92 based on the control instructions when determining that the predetermined condition is met based on the determination information. The communication unit 91a transmits the control signal generated by the controller 91b to the vehicle device 93. According to the server 91 configured as described above, a similar effect to that obtained by the meeting assistance apparatus 1 described in Embodiment 1 can be obtained.

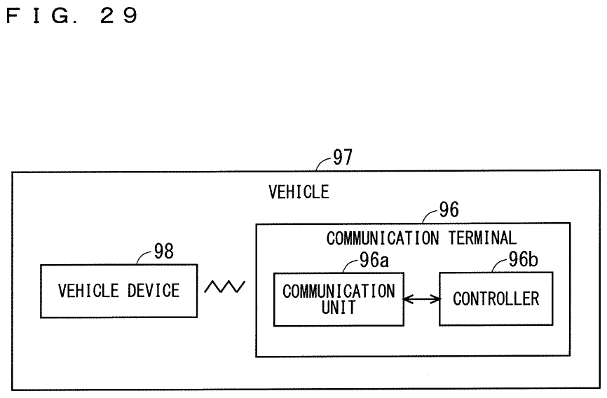

FIG. 29 is a block diagram showing a configuration of a communication terminal 96 according to a modification. The communication terminal 96 in FIG. 29 includes a communication unit 96a similar to the communication unit 91a and a controller 96b similar to the controller 91b, and can wirelessly communicate with a vehicle device 98 of a vehicle 97. A mobile terminal, such as a mobile phone, a smartphone, and a tablet, carried by a driver of the vehicle 97 is applied to the communication terminal 96, for example. According to the communication terminal 96 configured as described above, a similar effect to that obtained by the meeting assistance apparatus 1 described in Embodiment 1 can be obtained.

Embodiments and Modifications can freely be combined with each other, and can be modified or omitted as appropriate.

The foregoing description is in all aspects illustrative and not restrictive. It is understood that numerous unillustrated modifications can be devised.

### EXPLANATION OF REFERENCE SIGNS

1 meeting assistance apparatus, 11 acquisition unit, 12 controller, 21 body system device, 51 mobile terminal, 63 dispatch reservation server.

1. A meeting assistance apparatus to assist a meeting user and a vehicle in meeting at a meeting point, the meeting assistance apparatus comprising:
an acquisition circuitry to acquire, from a mobile terminal of the meeting user contracted with the vehicle, control instructions to control a body system device mounted to the vehicle and externally presenting audiovisual information; and
a controller to control the body system device based on the control instructions acquired by the acquisition circuitry when a predetermined condition to validate the control instructions is met.

2. The meeting assistance apparatus according to claim 1, wherein
the predetermined condition includes a distance between the vehicle and the meeting point or time required for the vehicle to arrive at the meeting point being less than or equal to a predetermined threshold.

3. The meeting assistance apparatus according to claim 1, wherein
the predetermined condition includes a speed of the vehicle being less than or equal to a predetermined threshold.

4. The meeting assistance apparatus according to claim 1, wherein
the predetermined condition includes the vehicle being stopped.

5. The meeting assistance apparatus according to claim 1, wherein
the predetermined condition includes the vehicle receiving operation to validate the control instructions.

6. The meeting assistance apparatus according to claim 1, wherein
the predetermined condition includes the mobile terminal receiving operation to ask for validation of the control instructions.

7. The meeting assistance apparatus according to claim 1, wherein
the body system device comprises a plurality of body system instruments, and
the predetermined condition is different for each of the body system instruments.

8. The meeting assistance apparatus according to claim 1, wherein
the body system device comprises a first body system instrument and a second body system instrument, and
the predetermined condition for the first body system instrument is more constrained than the predetermined condition for the second body system instrument.

9. The meeting assistance apparatus according to claim 1, wherein
the body system device comprises a plurality of body system instruments, and
the control instructions include information to identify one of the plurality of body system instruments controllable based on the control instructions, and to identify one of a plurality of controls of the one of the body system instruments.

10. The meeting assistance apparatus according to claim 1, wherein
the body system device comprises an audio output instrument to output audio to an exterior of the vehicle.

11. The meeting assistance apparatus according to claim 1, wherein
the body system device comprises an external display instrument to provide a display visible from an exterior of the vehicle.

12. The meeting assistance apparatus according to claim 1, wherein
the body system device includes at least one of an instrument to illuminate an exterior of the vehicle and an instrument to illuminate an interior of the vehicle.

13. The meeting assistance apparatus according to claim 1, wherein
the body system device comprises a plurality of body system instruments, and
the controller performs control to transmit a list or an image of the plurality of body system instruments controllable based on the control instructions from the vehicle to the mobile terminal.

14. The meeting assistance apparatus according to claim 1, wherein
the vehicle is an autonomous vehicle or a remotely operated vehicle driven by remote operation.

15. The meeting assistance apparatus according to claim 1, wherein
a meeting condition under which the meeting user and the vehicle meet is set by a server.

16. The meeting assistance apparatus according to claim 1, wherein
the control instructions are transmitted from the mobile terminal to the vehicle via a server.

17. A meeting assistance method of assisting a meeting user and a vehicle in meeting at a meeting point, the meeting assistance method comprising:
acquiring, from a mobile terminal of the meeting user contracted with the vehicle, control instructions to control a body system device mounted to the vehicle and externally presenting audiovisual information; and
controlling the body system device based on the acquired control instructions when a predetermined condition to validate the control instructions is met.

18. The meeting assistance apparatus according to claim 1, wherein
the control instructions include audio content or display content presented as the audiovisual information.
